(19) United States
(12) Patent Application Publication
(10) Pub. No.: US 2026/0175146 A1
(43) Pub. Date: Jun. 25, 2026

(54) RIGID FILTER SCREEN

(71) Applicant: CATALYST ENERGY SERVICES LLC, Odessa, TX (US)

(72) Inventors: Seth Moore, Odessa, TX (US); Sean Edwards, Odessa, TX (US); Don Gregory, Odessa, TX (US); Wesley Thomas, Odessa, TX (US)

(21) Appl. No.: 19/427,318

(22) Filed: Dec. 19, 2025

Related U.S. Application Data
(60) Provisional application No. 63/738,091, filed on Dec. 23, 2024.

(51) Int. Cl. B01D 29/11; B01D 29/41; B01D 46/00; B01D 46/24

(52) U.S. Cl. CPC B01D 29/114; B01D 29/41; B01D 46/0005; B01D 46/0006; B01D 46/0086; B01D 46/2403

(57) ABSTRACT

A system and method for a screen filter. The screen filter has a left side, a right side, a front side, and a rear side. The left and right sides are opposing sides. The front and rear sides are opposing sides. The front and rear sides intersect with a downstream side. Each side has a solid sheet of material with a plurality of voids located thereon. The voids allow air to pass through the filter.

### PRIORITY

The present invention claims priority to U.S. Provisional No. 63/738,091 filed Dec. 23, 2024, the entirety of which is hereby incorporated by reference.

### BACKGROUND OF THE INVENTION

### Technical Field

The present invention relates to a system and method.

### Description of Related Art

Turbines move significant volumes of air and at rates of speed. Debris which reaches the turbines can damage the turbine or other components. FIGS. 1 and 2 are perspective view of wire mesh. The wire mesh 101 can become dislodged and end up in the turbine. Even small metal frame pieces can damage the turbine or other components. Consequently, there is a need for a robust solution.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a perspective view of a prior art wire mesh filter;

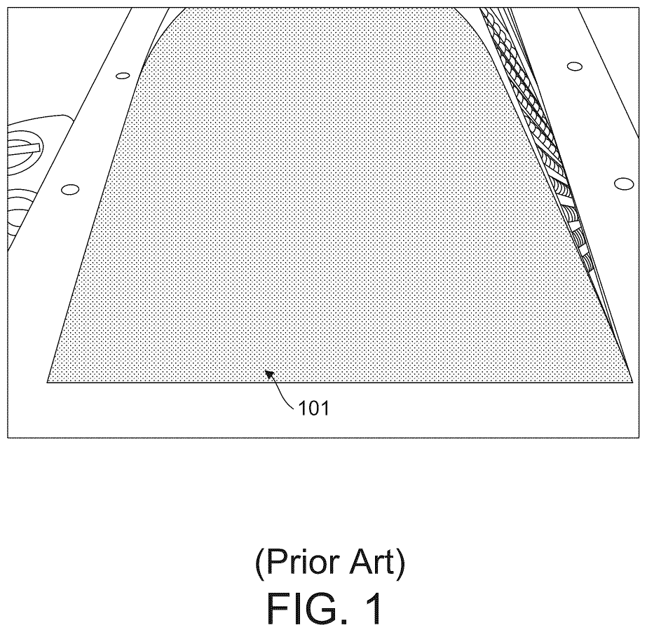

FIG. 2 is a perspective view of a prior art wire mesh filter;

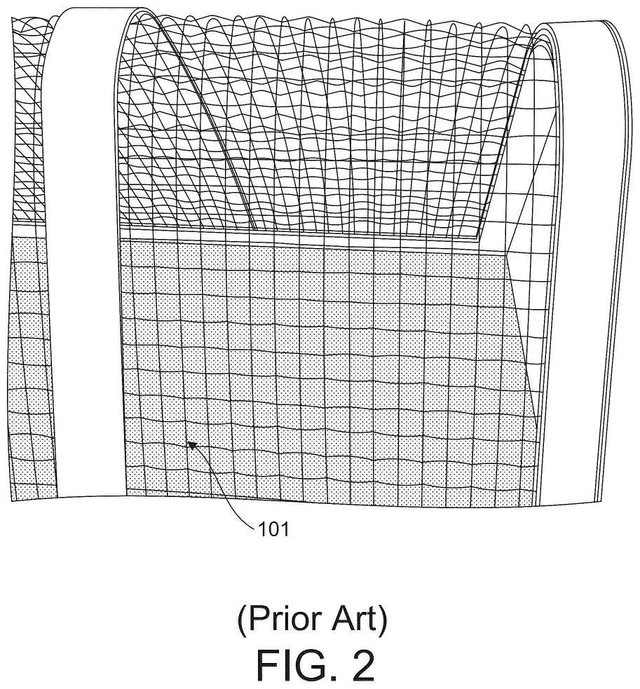

FIG. 3 is a perspective view of a rigid filter in one embodiment;

FIG. 4 is a perspective view of a rigid filter in one embodiment;

FIG. 5 is a side schematic view of a rigid filter and an intake in one embodiment;

FIG. 6 is a side schematic view of a rigid filter and an intake in one embodiment;

FIG. 7 is a top view wherein the voids are in off-set columns;

FIG. 8 is a top view wherein the voids have different orientations;

FIG. 9 is a top perspective view of a rigid filter in one embodiment;

FIG. 10 is a perspective view of a rigid filter in one embodiment.

### DETAILED DESCRIPTION

Several embodiments of Applicant's invention will now be described with reference to the drawings. Unless otherwise noted, like elements will be identified by identical numbers throughout all figures. The invention illustratively disclosed herein suitably may be practiced in the absence of any element which is not specifically disclosed herein.

As noted, the prior art utilized wire mesh or wire fabric. However, the metal becomes brittle, and subsequently breaks, and even small components can reach downstream of the filter and cause significant issues to the turbine or other components. As used herein, upstream and downstream refer to relative locations in a process. An upstream process is closer to where the process begins, i.e., receiving air, whereas the turbine is downstream. Even a small piece of wire mesh or wire fabric can significantly damage the turbine or other downstream engine components.

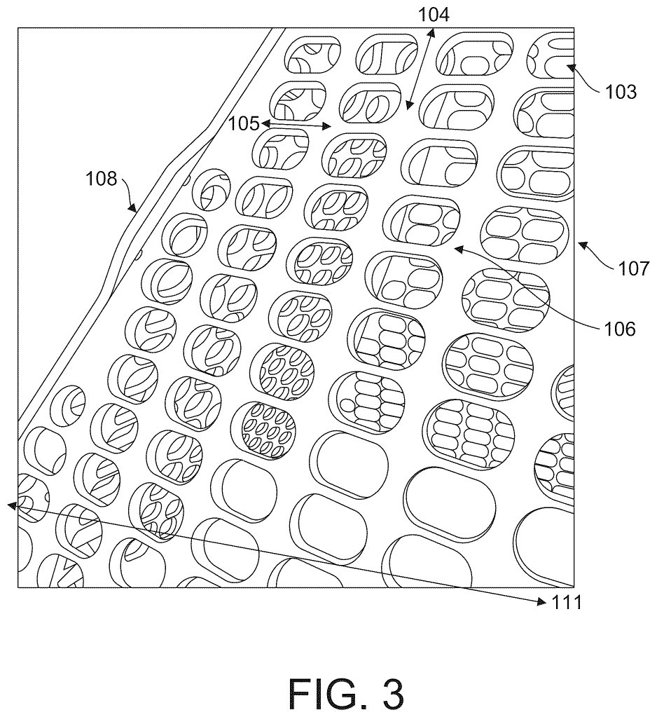

Accordingly, in one embodiment a rigid screen is developed which is placed upstream of the air intake box, as discussed herein. Turning to FIG. 3, FIG. 3 is a perspective view of a rigid filter 107 in one embodiment. As can be seen, rather than comprising strands of wire like the prior art, the screen comprises a solid piece of metal which has voids 103 therein. Again, rather than having distinct strands which make up the mesh, the rigid screen comprises a single sheet with voids cut therein. Such a system is far more rigid and structurally strong than wire mesh.

The rigid screen 107 does not comprise individual strands of wire which are woven to form a fabric or mesh. Instead, as noted, the rigid screen 107 comprises a solid piece of material which has voids 103 created therein. The result is a rigid and strong screen which will not break and fragment, which will be passed to the turbine or other downstream components.

FIG. 3 illustrates a rigid screen 107 which has a plurality of sides. The left side 111 is mostly visible in FIG. 3. Each side comprises at least solid piece of material which has a plurality voids 103 cut therein. Some sides may have one or more solid pieces of material coupled together. In other embodiments each side comprises only a single solid piece of material. Various materials can be used for the rigid screen 107. These include metals such as stainless steel, carbon fiber, etc. The screen can have virtually any material including metals, plastics, etc.

The sides can be coupled via any method known in the art. As shown, one side comprises a protrusion 108 which extends outwardly beyond the side which can be gripped, received, or otherwise coupled by an adjacent side to couple sides together. The sides can be welded together, or they can be friction fitted via a tongue and grove orientation.

The voids 103 can be cut into the solid cut into the solid piece via any method known in the art. These includes die cutting, laser cutting, 3D printing, etc. Alternatively, in other embodiments, the voids 103 can be formed when the solid piece is made.

The voids 103 can comprise virtually any shape. As depicted the voids 103 comprise an oval and sometimes circular shape. This is for illustrative purposes only and should not be deemed limiting. The shapes can be various polygons. The shapes can be circular, square, rectangle, diamond, triangle, trapezoid, polygon, combinations thereof, etc.

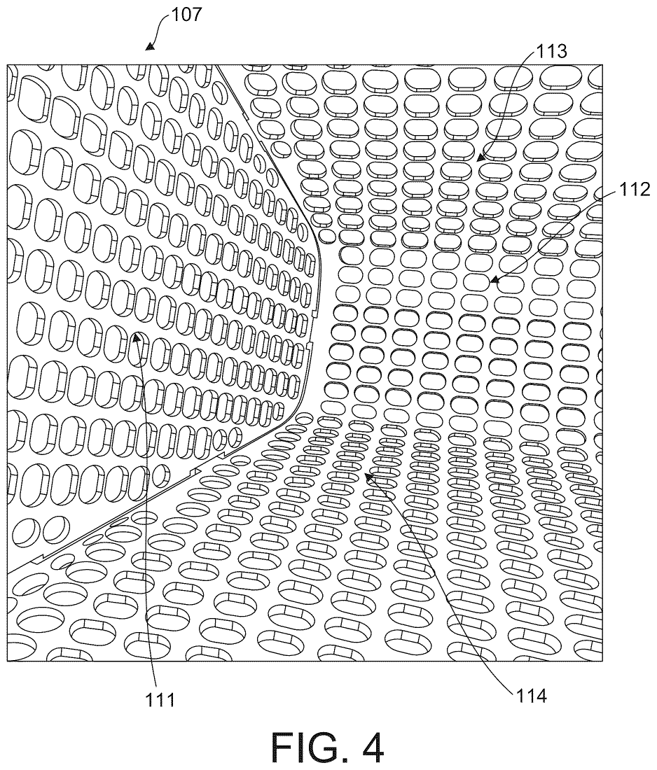

While in one embodiment the voids 103 comprise the same shape, in other embodiments two or more dissimilar shapes are utilized. As shown in FIGS. 3 and 4, two or more dissimilar shapes are utilized.

Because the rigid screen 107, in one embodiment, is utilized with a turbine which requires high flow rates of air, increasing the void surface area increases the surface area through which the air can flow. The void surface area is the total surface area of all of the voids 103. In one embodiment the void surface area 103 is greater than 40% of the total surface area of the rigid screen. In other embodiments the void surface area is greater than 50% of the total surface area of the rigid screen. In one embodiment, the void surface area is greater than 60% of the total surface area of the rigid screen. This means that of the total surface area of the screen, more than 60% is open via the voids 103. Increased open surface area results in increased air flow.

There are a variety of ways to increase the void surface area. One is increasing the size and/or shape of the void 103. However, increasing the size and/or shape of the void 103 increases the size through which a foreign object can pass. Therefore, there is a balance between increasing the void surface area but sacrificing filter effectiveness by allowing larger objects to pass therethrough.

As noted, the size and/or shape of the void 103 can vary. In one embodiment the void 103 has a diameter of about ¼ of an inch. In other embodiments, however, the size can vary. In most cases, a total effective flow area of a single void would be 0.11044 square inches or less-equal to about ⅜ of an inch circular void. Larger circular voids can be employed on each layer of screens if those screens are overlayed on each other to reduce the effective flow area of the combined system. For example, voids of 0.5 inches can be used if the screens are overlayed to obtain a reduced flow diameter.

A 0.11044 square inch void can be created in many different fashions. As one example, an oval or rectangle can offer a similar surface area but a comparatively smaller diameter. The size of the voids 103 will be dependent, in part, on the remaining air flow. The size of the void 103 can be decreased so long as the required air flow is not compromised. Thus, in one embodiment a void of about 6 mm can be utilized. In other embodiments, a void of about 4 mm can be used.

The voids 103 are flanked on either side by vertical cores 104. The vertical cores 104 extend generally vertically on either side of the voids 103. Similarly, the voids 103 are flanked by top and bottom by horizontal cores 105. The horizontal cores 105 extend generally horizontally on both the top and bottom of the voids 103. The horizontal cores 105 and the vertical cores 104 intersect at the core intersection 106. The blocked surface area is the sum of the surface area of all of the vertical cores 104, all of the horizontal cores 105, and all of the core intersection 106. The void surface area can be increased by decreasing the block surface area, which is the surface area which prevents the flow of air. The blocked surface area represents the portion of the solid sides 111 which have not been cut to create voids.

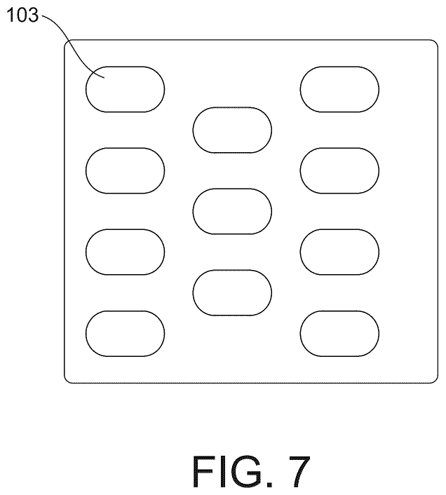

The embodiment depicted in FIG. 3 depicts an embodiment wherein the voids 103 are in rows and columns. This, however, is for illustrative purposes only and should not be deemed limiting. Turning to FIG. 7, FIG. 7 is a front elevation view wherein the voids are in off-set rows. As can be seen, columns 1 and 3 are horizontally and vertically aligned. However, column 2 is offset. The top-most void in column 2 is located vertically offset from the top void 103. As shown, in some embodiments, depending upon the size and shape of the voids 103, having vertically off-set rows can decrease the surface area of the core intersection 106. In so doing, this geometric arrangement can increase the void surface area. The voids 103 can be vertically offset, horizontally offset, or both.

Turning to FIG. 4, FIG. 4 is a perspective view of a rigid filter in one embodiment. As can be seen, this rigid filter screen 107 has one left side 111, an integrated downstream side 112, the rear side 113 and the front side 114. The right side 115 mimics and opposes the left side 111. In one embodiment, the left side 111 and the right side 115 face one another. In one embodiment the left side 111 and the right side 115 are in parallel planes. The front side 114 and rear side 113 also oppose one another. In one embodiment the front side 114 and rear side 113 are in parallel planes.

The upstream side (not shown) is opposite the downstream side 112. The upstream side can be open, meaning there is no side on the upstream end connecting the left side 111 and the right side 115. In other embodiments, however, there is a side connecting the left side 111 and the right side 115 which has voids 103 similar to the other sides discussed herein.

As depicted, the integrated downstream side 112, rear side 113, and front side 114 comprise a single integrated piece. The left 111 and right sides 115 are coupled to this integrated piece to form the rigid filter screen 107. While it is shown that the integrated piece is a single piece, this is for illustrative purposes only and should not be deemed limiting. In other embodiments these are several distinct pieces which are coupled to one another.

As can be seen, the filter screen 107 shown in FIG. 4 can be inserted or placed adjacent to the air intake 109.

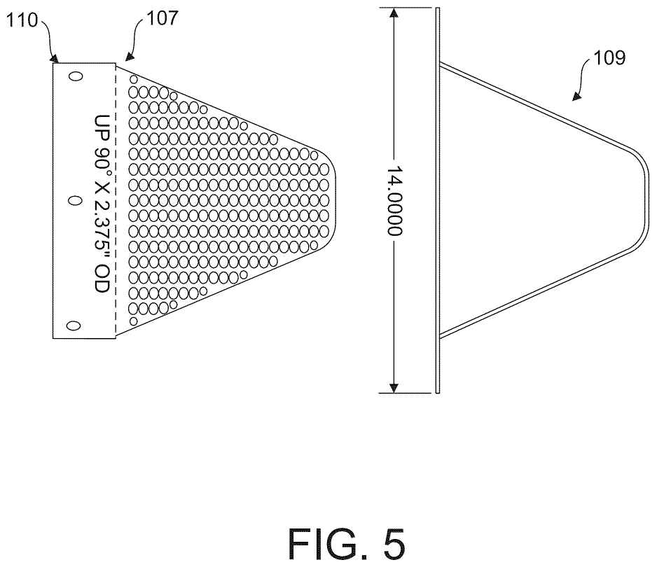

Turning to FIG. 5, FIG. 5 is a side schematic view of a rigid filter and an intake in one embodiment. The air intake 109 can comprise virtually any air intake whereby air is collected and introduced to a system. As can be seen, the filter screen 107 is three-dimensional as opposed to a thin traditional screen. The filter screen 107 comprises a height, a width, and a depth. As depicted, the filter screen 107 fits within the air intake 109 system in the stream of air. Alternatively, the filter screen 107 can be coupled upstream of the air intake 109 to act as an upstream filter of the air intake 109.

As shown, the air intake 109 comprises a concave shape, whereas the rigid filter 107 comprises a matching convex shape which can be received by the air intake 109. In another embodiment the rigid filter can be configured in a concave arrangement.

As shown, on an upstream end of the filter screen 107 is a coupler 110. The coupler 110 provides an opportunity to couple or connect the filter screen 107 to other equipment, an additional filter, etc. The coupler 110 can be used to couple the filter screen 107 to the air intake 109.

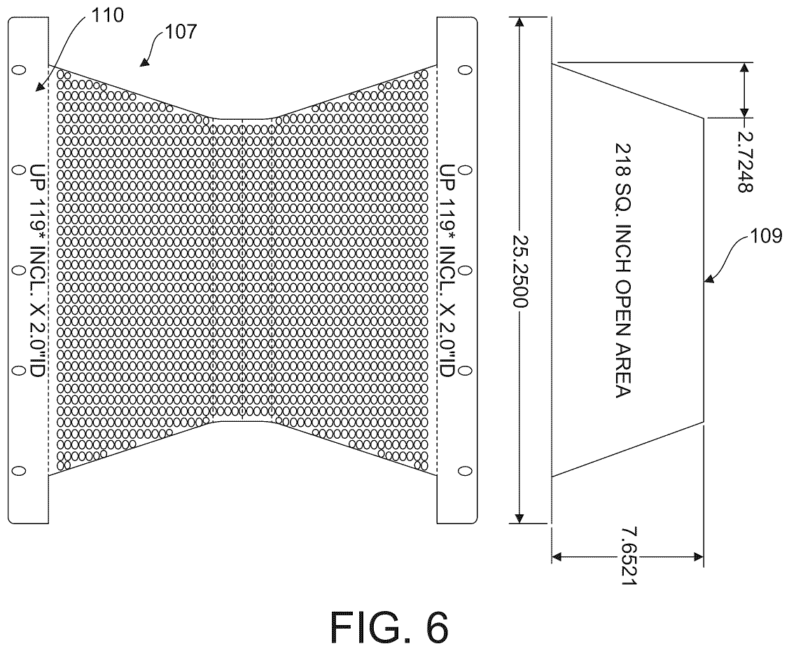

FIG. 6 is a side schematic view of a rigid filter and an intake in one embodiment. The rigid filter 107 can be placed adjacent to the air intake 109, as depicted. Or, a portion of the rigid filter 107 can be housed within the air intake 109. The shape of the filter is designed to allow for adequate airflow across wide operating ranges and amounts of debris capture. The airflow is directly proportional to the total surface area of the filter face and void size, shape and number. By building a filter that is not flat, it allows the filter face to contain more surface area from which to cut voids, thus increasing the effective flow area of the system itself. Additionally, the filter, in its current embodiment, is designed so that debris, once captured, is directed to the side of the enclosure and away from the center of airflow—where air flow velocities are typically highest. This minimizes the sometimes negative effects of debris with regards to airflow disruption (gets it out of the direct flow path of incoming air), and minimizes the chance that prolonged airflow will deteriorate the debris to such a point that it may be reduced in size and thus advance further into the air system/turbine engine.

As noted, while a filter screen 107 has been shown, there can be additional particulate and other filter types. Such filters can be upstream of the filter screen 107 or downstream of the filter screen 107. In one embodiment the system utilizes one or more filters upstream of the filter screen 107. As but one example, in one embodiment an air particle separator is upstream of the filter screen 107. In another embodiment, downstream of the air particle separator is upstream of a particulate air filter. The particulate air filter is upstream of the filter screen 107. The filter screen 107 offers an additional layer of protection if the two upstream filters are compromised.

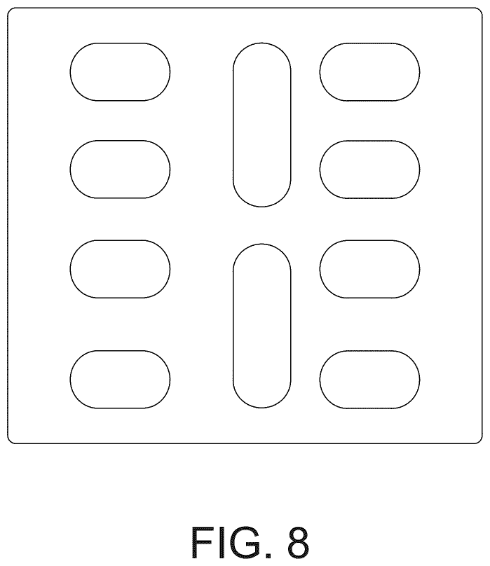

FIG. 8 is a top view wherein the voids have different orientations. FIG. 8 shows oval voids 103 as in FIG. 7. However, the ovals voids 103 in the first and third columns are horizontally oriented whereby the large diameter is horizontally oriented. The voids 103 in the center column are vertically oriented. As noted, the size, shape, and orientation can be modified to optimize surface area and air flow. In some embodiments, varying border thickness can create weak points. Thus, in some embodiments, the border between voids 103 can be optimized to minimize weak points.

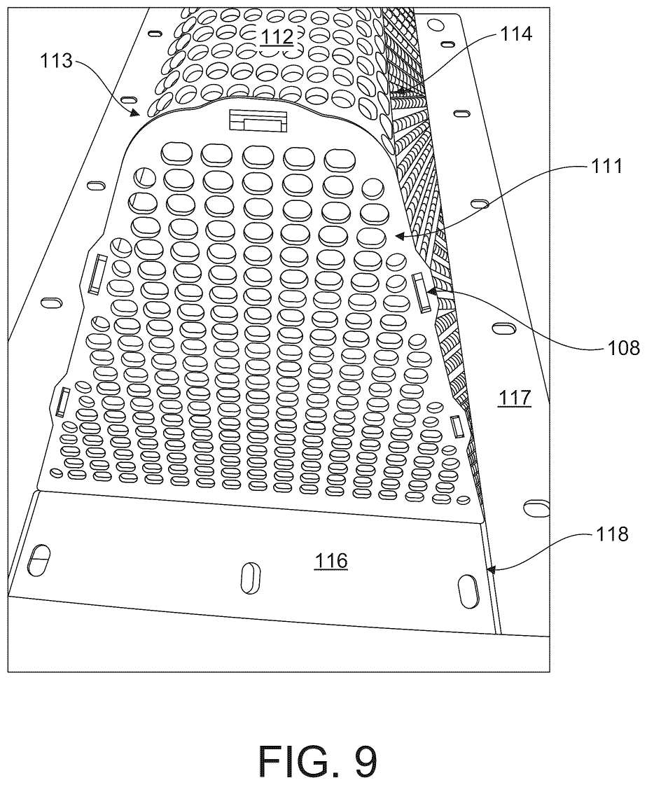

FIG. 9 is a top perspective view of a rigid filter in one embodiment. FIG. 9 shows one embodiment of how the filter is connected. This is for illustrative purposes only and should not be deemed limiting. As shown, this filter comprises three separate components which are connected. The left side 111 with the end flange 116 constitutes the first piece. The center piece comprises an integrated rear side 113, front side 114, downstream side 112 and the associated center flange 117 make up the second piece. The third piece includes the right side 115 and its associated end flange 116.

The first and third pieces can be coupled or attached to the center piece in any method known in the art. As shown, the center piece comprises protrusions 108 which can be inserted through voids in the left side 111, as shown. The protrusions 108 can then be bent to lock the side in place relative to the center piece. The protrusion 108 can, if desired, be welded to ensure proper securement.

As shown, each side piece 111, 115 has an end flange 116. This is a flat planar piece. The side can be die cut to create the voids 103, and then bent as necessary to create the side piece with flange 116. The flange 116 offers a border for the filter. The flange 116 also offers holes on which the flange 116 can be coupled to structure, machinery, etc. Further, end flange 116 can be coupled or attached to the center flange 117. As shown, the two pieces are coupled via a flange weld line 118. A weld line 118 offers an additional support for the adjacent pieces. In one embodiment the weld line 118 comprises a thin bead. Given the high air flow rates, as high as 200 mph or higher, a thin bead reduces the likelihood that the weld can be worn and damage downstream equipment.

In one embodiment the center piece comprises a single integrated planar piece. The voids are created as previously described. Thereafter, the center piece is bent and formed as necessary to create the center piece. As shown the center piece has flanges on each side which function similarly to the end flange 116.

Having three components eases manufacturing and installation. There are few parts.

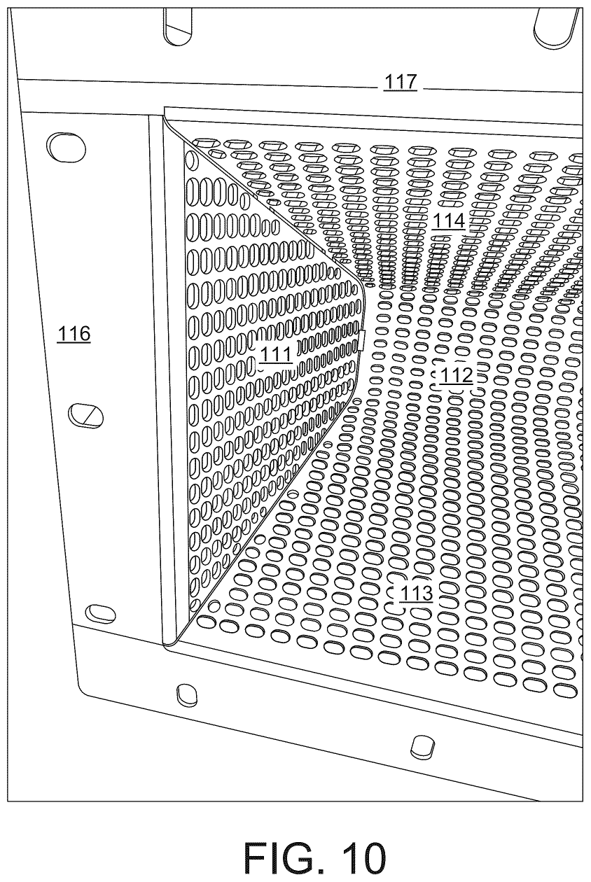

FIG. 10 is a perspective view of a rigid filter in one embodiment. This further illustrates how the three components can be coupled to form a rigid filter.

In one embodiment the voids are cut perpendicular to the surface. This means the walls (edges) of the voids are perpendicular to the face of the material. This is for illustrative purposes only, however, and should not be deemed limiting. In other embodiments, the voids are cut at an angle relative to the normal face of the sheet. For example, the voids can be cut such that the sides of the voids 103 are at a 30 degree, 120 degree, etc. relative to the normal face of the sheet. The angle of the cut impacts the flow properties of the air. In some embodiments, the user desires non-turbulent airflow. The angle of the void walls can impact the flow characteristics of the air flow. Such properties can be optimized by adjusting the angle of the void. But cutting the voids so that their walls (edges) are parallel to the direction of airflow, air movement can be optimized to maintain a state of laminar flow and avoid a situation where transitional or turbulent air flow is induced due to an improperly designed/configured air intake system components, including the rigid filter.

There are many advantages to this system. First, as noted, compared to prior art wire mesh which can be prone to snapping or breaking, the rigid filter screen 107 will not. As noted, even small pieces of prior art wire mesh can become dislodged. This can result, in the minimum, the turbine shutting down due to foreign object detection technology. Worse, the pieces can damage the turbine or other downstream equipment. Thus, the system offers a robust solution which will not deteriorate. The filters discussed herein are durable, and more resistant to debris-induced fatigue and wear. The filters are more resistant to damage caused by impacts from foreign objects. Further, the filters are less susceptible to being damaged during installation. There is a high degree of chemical resistance due to stainless steel properties, even though the rigid filter can be made from mild steel or other suitable materials.

The prior art wire mesh has weak points caused by the creation of the mesh. If the mesh is bent, this creates even further weak spots. These weak spots are susceptible to being broken or damaged, compromising the integrity of the filter. As noted, if the mesh or wire breaks, this can move downstream damaging the engine, turbine, etc.

As noted, the rigid system is more durable than a mesh system. As but one example, if a bolt is collected within the rigid filter, the filter may last 50,000 hours or more after the introduction of the bolt. However, the mesh system would wear out much sooner. The increased life of the rigid filter allows issues, like a bolt, to discovered prior to failure.

Furthermore, as noted, the air flow often has significant speeds. The flow rate can be 200 mph, or faster. This often causes vibration in the prior art systems. The vibration and movement can lend to fatigue and failure of the mesh system. Conversely, the rigid filter does not vibrate but rather holds form.

While the invention has been particularly shown and described with reference to a preferred embodiment, it will be understood by those skilled in the art that various changes in form and detail may be made therein without departing from the spirit and scope of the invention.

What is claimed is:

1. A screen filter comprising:
a left side;
a right side;
a front side;
a rear side;
wherein said left side and said right side are on opposing sides, and wherein the front and rear sides are on opposing sides;
wherein the front and rear sides intersect with a downstream side;
wherein each side comprises a plurality of voids located within a solid sheet of material.

2. The screen filter of claim 1 wherein each side comprises vertical cores vertically adjacent to said plurality of voids, and horizontal cores horizontally adjacent to said plurality of voids, and wherein said vertical cores and said horizontal cores intersect at a core intersection.

3. The screen filter of claim 1 wherein said plurality of voids are organized in columns and rows.

4. The screen filter of claim 1 wherein adjacent columns are vertically aligned.

5. The screen filter of claim 1 wherein adjacent columns are vertically off-set.

6. The screen filter of claim 1 comprising an open upstream end.

7. The screen filter of claim 1 further comprising an upstream side which comprises a plurality of voids.

8. The screen filter of claim 1 wherein said plurality of voids are cut from said solid sheet of material.

9. The screen filter of claim 1 wherein said material comprises steel.

10. The screen filter of claim 1 wherein said screen filter is upstream of an air intake.

11. The screen filter of claim 1 wherein said material comprises carbon fiber.

12. The screen filter of claim 1 wherein said plurality of voids comprises dissimilar shapes.

13. The screen filter of claim 1 wherein each side has a total surface area and a void surface area, and wherein said void surface area is greater than 50% of the total surface area.

14. The screen filter of claim 1 wherein said void comprises a diameter of about 4 mm.

15. The screen filter of claim 1 wherein said downstream side, rear side, and front side comprise a single integrated piece.
